(19) United States
(12) Patent Application Publication
(10) Pub. No.: US 2008/0160299 A1
(43) Pub. Date: Jul. 3, 2008

(54) Heat shielding sheet

(75) Inventors: Hiroki Mori, Ashikaga-shi (JP); Masaaki Sato, Ashikaga-shi (JP); Takuo Suzuki, Ashikaga-shi (JP); Makiko Sakurazawa, Ashikaga-shi (JP)

Correspondence Address: KANESAKA BERNER AND PARTNERS LLP, 1700 DIAGONAL RD, SUITE 310, ALEXANDRIA, VA, 22314-2848, US

(73) Assignee: ACHILLES CORPORATION, Tokyo (JP)

(21) Appl. No.: 11/709,142

(22) Filed: Feb. 22, 2007

(30) Foreign Application Priority Data
Dec. 27, 2006 (JP) 2006-351005

(51) Int. Cl. B32B 27/06

(52) U.S. Cl. 428/340

(57) ABSTRACT

There is provided a heat shielding transparent sheet which transmits visual light but cuts infrared light and is remarkably resistant to climate and thermal deterioration even in an environment of outdoor use, the sheet comprising a synthetic resin with 0.4 to 2.7 g/m² of Tungsten Oxide particles and having visible light transmittance of 70% or more and sunlight transmittance of 65% or less, respectively.

### BACKGROUND OF THE INVENTION

1. Field of the Invention

This invention relates to a sheet/film for heat/thermo shielding from the sun light with highly transparency in visible light region but cuts infrared light region. The light in the infrared region is so-called “heat rays” and enhances thermal built up when irradiate to the objects. Particulars of this invention relate to an infrared absorbing sheet/film with high visible light transparency and improved weatherability. Better weatherability makes it possible to use the sheet/film under sunlight and severe thermal environment.

2. Background Technology

The sunlight comprises visible light rays of 380 to 780 nm (in wavelength), ultraviolet light rays of 200 to 380 nm and infrared light rays of 780 nm or more in wavelength.

Especially, near infrared light rays of 780 to 2,100 nm in wavelength are so-called “heat rays”, and easily converted into heat when light is irradiated.

Colored films, metallized films, etc. have been proposed to reduce rise in temperature caused by near infrared light rays in the sunlight.

Although these films show an effect to cut heat rays, as well as visible light rays thereby the film having less transparency and visibility problems when applied on a window glass.

There have also been proposed films comprising Indium-doped Tin Oxide (hereinafter referred to as ITO) and Antimony-doped Tin Oxide (hereinafter referred to as ATO) as an infrared light protective material having higher transmittance in the visible light region compared with the above mentioned colored or metallized films (see, Japanese Patent-A No. 2004-91589, etc.)

However, in case of ITO, the wavelength of 900 nm or higher can be defiladed but difficult to cut that of around 780 to 900 nm in wavelength region. Thus, in order to obtain a desirable level of sunlight cutting performance, amount of ITO should be increased. Further, when ITO is applied on the surface of films by means of metallizing or spattering, the surface in appearance tends to glare undesirably because of reflection.

With regard to ATO, the wavelength where light rays are initially cut also lies slightly to the longer wavelength side although it is not more than that of ITO, while some light ray is absorbed even in the visible light region, which makes the film dark. It is a problem that the transmittance of visible light rays might be further decreased, in order to obtain a required performance of sunlight cutting. Further, in fact, antimony itself has toxic consequences.

On the other hand, slightly reduced-Tungsten Oxide and Molybdenum Oxide membranes have been disclosed in Japanese Patent-A No. 8-59300, etc. These membranes are well known as a so-called electro-chromic material, which is transparent in a fully oxidized state but absorbs light rays in a region from visible light to near infrared light when the material is reduced by an electrochemical process. Conventional sunlight shielding materials added with Tungsten Oxide or molybdenum Oxide are prepared by means of spattering. In such a physical surface modification method, however, large-scaled equipments and vacuum units are necessary for the process, thereby unexpectedly increasing the cost of production even though the productivity is improved and large size products can be yielded.

Furthermore, it has been required from a standpoint of practical use of sunlight-shielding materials to improve the light transmittance in the visible light region without decreasing the cutting performance in the infrared. The performances change due to oxidation or decomposition in a single layer, while durability thereof is also a point of question.

When the above mentioned heat shielding sheets are used in the open air, for example, film for window glass or an awning. The sheet is exposed not only to rain or cleaning fluid but also to the ultraviolet light which accelerates deterioration of resins and decreases physical properties as well as heat shielding performance. Even though, it is difficult to keep sufficient higher transparency of visible light or haze for a long period of time.

[Patent Reference No. 1] Japanese Patent-A No. 2004-91589

[Patent Reference No. 2] Japanese Patent-A No. 8-59300

[Patent Reference No. 3] WO No. 2005-037932

[Patent Reference No. 4] Japanese Patent-A No. 2005-187323

### SUMMARY OF THE INVENTION

Accordingly, it is an object of this invention to provide a transparent heat shielding sheet, which exhibits an excellent heat light shielding effect and keeps improved wheatherability and thermal stability. It maintains transparency of visible light for a long period of time even exposed to the sunlight.

### DETAILED DESCRIPTION

### Problems to be Solved by the Invention

The inventors have eagerly investigated to solve the above mentioned problems and finally completed the invention based on a finding in which a specific amount of Tungsten Oxide particles are used as an infrared absorbing agent to effectively shield heat light related to rise in temperature without remarkably decreasing the transmittance of visible light. And combination of the light stabilizers dramatically improves its wheatherability and helps long time infrared shielding performance with higher visible light transmittance. Hence, the sheet can be used a severe condition exposed to the sun light.

A heat shielding sheet of the invention comprises a synthetic resin in which 0.4 to 2.7 g/m² of Tungsten Oxide particles are added to keep the transmittance of visible light to a level of 70% or more and that of the sunlight to a level of 65% or less.

It is preferable to add 0.01 to 10 parts by weight of a light stabilizer to 100 parts by weight of the resin, which makes it possible to keep the transmittance of sunlight in the ultraviolet region to a level of 10% or less, improve wheatherability and cut ultraviolet light transmitted therethrough.

Preferably, the light stabilize is a mixture of at least three compounds of cyanoacrylate, benzotriazole and hindered amine. And more preferably, cyanoacrylate is a major ingredient. It is further preferable that the light stabilizer comprises about 70 to 50% of the cyanoacrylate compound, about 25 to 40% of the benzotriazole compound and about 5 to 10% of hindered amine compound.

According to the invention, there may be prepared a composition comprising Tungsten Oxide particles in a thoroughly dispersed state in a specific amount of synthetic resin or additive in advance, which is then added to the synthetic resin as a matrix resin of the heat shielding sheet so that the Tungsten Oxide particles are almost homogeneously dispersed in the sheet.

A matrix resin as the (base) matrix resin of the present invention may be any synthetic resin useful in general for films and sheets and be properly selected depending on the purpose.

The synthetic resin used in the invention includes, for example, polyvinyl chloride resins, polyolefin resins, polyester resins, polycarbonate resins, acrylic resins and the like, and polyvinyl chloride and polyolefin resins are particularly used from a standpoint of stability to light and also processability. There may be used a combination of two or more selected from those resins as described above depending on the purpose.

The polyvinyl chloride resins include a homo-polymer of vinyl chloride, a co-polymer of vinyl chloride and other monomers, a mixture thereof, a blend of vinyl chloride homo-polymer or copolymer resin with other resins, and the like, which will hereinafter be simply referred to as polyvinyl chloride resins.

The monomers to be copolymerized with the polyvinyl chloride resins include vinyl acetate, ethylene, propylene, maleic ester, methyl methacrylate, methacrylic ester, vinyl ether and the like.

The other resins to be blended with the polyvinyl chloride resins include an ethylene-vinyl acetate copolymer resin, an acrylonitrile-butadiene-styrene terpolymer, an acrylonitrile-butadiene copolymer and the like.

The polyolefin resins include an α-olefin homo-polymer and a copolymer of α-olefin monomer as a main component with different monomers such as ethylene and propylene, or an ethylene-propylene dimmer, an ethylene-butene dimmer, an ethylene-4-methyl-1-pentene dimmer, an ethylene-vinyl chloride dimmer, an ethylene-acrylic acid dimmer and the like.

The polyester resins include polytrimethylene terephthalate and other ester resins.

A characteristic feature of the invention is that the heat shielding sheet comprises 0.4 to 2.7 g/m² of Tungsten Oxide particles, in which the transparency of visible light is 70% or more and the transparency of the sunlight is 65% or less.

A smaller amount of Tungsten Oxide particles than as described above would cause an insufficient heat shielding effect, while a larger amount of the particles would not only saturate the effect but excessively increase absorption in the visible region, thereby the sheet being colored undesirably.

Thickness of the present sheet may range in the standard as general sheets, for example, about 50 to 350 μm and preferably, 75 to 250 μm.

It is preferable that the Tungsten Oxide particles are dispersed in the sheet in a state of almost homogeneous dispersion. In other words, a specific amount of the Tungsten Oxide particles might be dispersed throughout a unit area of the sheet in spite of thickness thereof, while the important point is the amount of 0.4 to 2.7 g/m². In the case of the polyvinyl chloride resins as the matrix resin, for example, an amount of the Tungsten Oxide particles per 100 parts by weight of the resin is preferably about 8 to 4.0, 0.4 to 2.0 and 0.25 to 1.35 parts by weight for the heat light ray absorbing sheets of 100, 200 and 300 μm in thickness, respectively.

The Tungsten Oxide particles used in the invention include those fine particles described in WO No. 2005/037932, Japanese Patent-A No. 2005-187323, etc. and represented by the following general formula:

W_{y}O_{z}

wherein W is Tungsten, O is oxygen and 2.2≦z/y≦2.999 or composite fine particles represented by the following general formula:

MₓW_{y}O_{z}

wherein M is one or not less than two of elements selected from a group including H, He, alkaline metal, alkaline earth metal, rare earth element, Mg, Zr, Cr, Mn, Fe, Ru, Co, Rh, Ir, Ni, Pd, Pt, Cu, Ag, Au, Zn, Cd, Al, Ga, In, TI, Si, Ge, Sn, Pb, Sb, B, F, P, S, Se, Br, Te, Ti, Nb, V, Mo, Ta, Re, Be, Hf, Os, Bi and I; W is Tungsten, O is oxygen, 0.001≦x/y≦1 and 2.2≦z/y≦3.0.

In order to improve the transmittance of visible light and at the same time having higher heat shielding performance, a diameter of the Tungsten Oxide particles dispersed in the sheet is preferably 500 nm and more preferably 100 nm as the average particle size D₍₅₀₎.

Those particles grater than D₍₅₀₎=500 would cause a decrease in the transmittance of visible light and become hazy.

Employment of such Tungsten Oxide particles makes it possible to cut heat light rays related to rise in temperature more effectively than conventional ITO and ATO. The Tungsten Oxide particles have better infrared absorption performance in a small amount, thereby improving the transmittance of visible light through the sheet. In addition, the sheet can be used effectively for a long period of time even in the open air because of the particles of outstanding resistance to light rays.

If the Tungsten Oxide particles are not dispersed homogeneously in the sheet, there causes various problems such as insufficient heat shielding performance and deformation during use. Further, insufficient dispersion of the particles causes coagulation and never results in particle size less than 500 nm.

One example to improve dispesibility of the Tungsten Oxide particles is that the particles may be coated by dispersant or added with a suitable dispersant to the resin.

A coupling agent comprising an element such as Si, Ti, Zr and Al is used as the coating agent and, for example, a silane coupling agent, e.g., methoxysilane is preferably used.

A variety of surfactants and phosphate compounds are properly used as the dispersant.

According to the invention, there may be prepared a composition in advance by dispersing a required amount of the Tungsten Oxide particles in a specific amount of the resin, which is then added to the matrix resin for the sheet to achieve homogeneous dispersion.

The specific amount of the resin is preferably about 1 to 10% of the sheet forming resin in total. The amount less than 1% does not exhibit the effect of pre-dispersion of the particles, while the amount more than 10% makes it difficult to disperse the particles into prepared composition in the matrix resin.

When the matrix resin is the polyvinyl chloride, a plasticizer is generally added thereto.

According to the invention, a required amount of the Tungsten Oxide particles may be dispersed in advance in an additive such as the plasticizer, and the additive is then added to the matrix resin to achieve homogeneous dispersion.

In a couple of manners as described above, dispersibility of Tungsten Oxide in the synthetic resin can be improved.

The plasticizers used in the invention include a phthalate plasticizer such as di-2-ethyhexyle phthalate (DOP), diisononyl phthalate (DINP) and butylbenzyl phthalate (BBP), a phosphate plasticizer such as tricresyl phosphate (TCP), an adipate plasticizer such as di-2-ethylhexyl adipate (DOA), a sebacate plasticizer such as di-2-ethylhexyl sebacate (DOS), an azelate plasticizer such as di-2-ethylhexyl azelate (DOZ), a polyester plasticizer such as polypropylene adipate (PPA), a chlorinated aliphatic ester plasticizer and the like, which may be used independently or as a combination of two or more thereof.

The heat shielding sheet of the invention may comprise, other than the Tungsten Oxide particles and the plasticizer, light stabilizers, another stabilizer, a lubricant, a colorant, a dispersing agent, a viscosity modifiers and other kinds of additives, if necessary. Addition of such colorants and some others should be done with regard to a decrease in transmittance in the visible light region.

The synthetic resin composition comprising the Tungsten Oxide particles and other additives may be subjected to various sheeting processes such as calendering, extrusion, inflation and casting to yield the heat shielding sheet.

According to the invention, inclusion of the light stabilizers in the heat shielding sheet makes it possible to prevent change in color and shapes due to the effect of ultraviolet light exposed in the sunlight. with keeping better the visible light transmittance.

The light stabilizer is preferably added in an amount of 0.01 to 10 parts by weight to 100 parts by weight of the matrix synthetic resin.

An amount of the light stabilizer smaller than as described above insufficiently prevents physical changes caused by the sunlight in the synthetic resin so that outstanding resistance to climate would hardly be kept over a long period of time. On the other hand, an excessive amount thereof only saturates the above mentioned effect and causes a phenomenon of bleeding out on the sheet surface, thereby the transmittance of visible light rays being reduced undesirably.

The light stabilizer includes one or more compounds selected from a group consisting of a benzophenone compound, a cyanoacrylate compound, a benzotriazole compound, a salicylic ester compound, a triazine compound and a hindered amine compound.

Particularly, it is possible to improve wheatherability to light of the synthetic resin to be used by using three compounds simultaneously. Combination of cyanoacrylates, benzotriazoles and hindered amines shows better results.

When these three compounds as mentioned above are simultaneously used as the light stabilizer, preferably cyanoacrylate is a main component.

The cyanoacrylate compound as a main component is preferably used in an amount of about 70 to 50% to a total amount of the light stabilizers, while the amounts of the benzotriazole and hindered amine compounds are about 25 to 40% and about 5 to 10%, respectively.

When a ratio of the cyanoacrylate compound to the benzotriazole and hidered amine compounds in the total amount of the light stabilizers is less than 50% or more than 70%, a mutual interaction derived from a simultaneous combination of the three compounds is not exhibited so that the ultraviolet region is insufficiently absorbed to cause change in color of the synthetic resin. Hence, long term wheatherability is not obtained, moreover the Tungsten Oxide degenerates and, as a result, absorbability of near infrared light becomes exacerbated.

The cyanoacrylate compounds used in the invention include 2-ethylhexyle 2-cyano-3,3-diphenyl acrylate, ethyl 2-cyano-3,3-diphenyl acrylate, octyl 2-cyano-3,3-diphenyl acrylate and the like.

The benzotriazole compounds include 2-(2′-hydroxyphenyl)benzotriazole, 2-(2′-hydroxy-5′-methylphenyl)benzotriazole,2-(2′-hydroxy-5′-methylphenyl)-5-carboxylic acid butyl ester benzotriazole, 2-(2′-hydroxy-5′-methyl)-5,6-dichlorobenzotriazole, 2-[2′-hydroxy-3′-(3″,4″,5″,6″-tetrahydrophthalimidemethyl)-5′-methylphenyl]benzotriazole, 2-[2-hydroxy-3,5-bis(α,α-dimethylbenzyl)phenyl]-2H-benzotriazole, 2,2′-methylenebis[4-(1,1,3,3-tetramethylbutyl-6-82H-benzotriazole-2-yl)phenol and the like.

The hindered amine compounds include 4-(phenylacetoxy)-2,2,6,6-tetramethylpiperidine, tris(2,2,6,6-tetramethyl4-piperidyl)triazine-2,4,6-tricarboxylate, 2,2,6,6-tetramethylpiperidyl-4-benzoate, bis(2,2,6,6-tetramethyl-4-piperidyl)sebacate, tris(2,2,6,6-tetramethyl-4-piperidinyl)phosphate, 1,3,8-triaza7,7,9,9-tetramethyl-3-n-octylpyro [4,5]decane-2,4-dion, 1,2,3,4-tetra84-carbonyloxy-2,2,6,6-tetramethylpiperidyl)butane, 1,3,8-triaza-7,7,9,9-tetramethyl-2,4-dioxospiro[4,5]decane, tri(4-acetoxy-2,2,6,6-tetramethylpiperidyl)anine, 4-stearoyloxy-2,2,6,6-tetramethylpiperadine, 4-benzyloxy-2,2,6,6-tetramethylpiperidine, 4-phenylcarbamoyloxy-2,2,6,6-tetramethylpiperadine, 4-p-toluenesulfonyloxy-2,2,6,6-tetramethylpiperidine, bis(2,2,6,6-tetramethyl-4-piperidyl) terephthalate and the like.

The heat shielding sheet itself is necessarily exposed to an environment of medium temperatures for a long period of time, because the Tungsten Oxide particles in the sheet absorbs light rays in the infrared region, especially near infrared region and raise the temperature to 40 to 60° C. (medium temperature).

According to the invention, there may be added additional stabilizer effective for medium temperatures to prevent deterioration of the synthetic resin. It is preferable to add this additional “heat” stabilizer in an amount of about 1 to 10 parts by weight to 100 parts by weight of the synthetic resin. Compounds of zinc, sodium, etc. can be used as the stabilizer.

The transmittance of visible light rays through the heat shielding sheet of the invention is 70% or more, calculated according to a procedure prescribed by JIS-A-5759, while that of sunlight is 65% or less and, in the ultraviolet region, is preferably 10% or less. More preferably, the transmittance of sunlight in the near infrared region is 35% or less and that of ultraviolet light is 1% or less while keeping the transmittance of visible light at a level of 70% or more.

The heat shielding sheet of the invention can be used almost everywhere, for example, inside or outside of window glass of buildings, vehicles, etc.

The heat shielding sheet may be given a self-tack nature by increasing a load of the plasticizer or adding a tackifier. On the contrary, a self-adhesive layer may be formed on either surface of the sheet.

The heat shielding sheet of the invention may be a laminate of two or more layers, in which at least one layer is a sheet of synthetic resin comprising the Tungsten Oxide particles.

A layer to be laminated to the heat shielding sheet may be a generally used sheet having properties other than heat cutting performance.

For example, there may be used a designed layer for the purpose of improving appreciation or a protective layer for preventing surface scratching of the sheet.

The designed layer may be formed by pattern printing (stained-glass styles, flowers, stripes, etc.), over-all-paint printing or letter printing in the conventional technical manners of screen printing, gravure printing, offset printing and the like. It is possible to adjust inside lightness of the heat shielding sheet by means of the designed layer. Formation of the designed layer sometimes makes it difficult to keep the transmittance of visible light and the sunlight at levels of 70% or more and 65% or less, respectively, however, the heat cutting performance can be obtained if the transmittance of both lights through the heat shielding sheet as the base sheet is maintained.

There may be formed the protective layer by coating the surface of the sheet with a generally used over coat materials such as polyurethane, polyvinyl acetate, acryl resin and the like as a single polymer, copolymer or mixture of two or more thereof.

The heat shielding sheet of laminated type as described above includes, for example, sheet structures formed by sandwiching a reinforcing material such as fabric, non-woven fabric, knit fabric and net. A reinforcing material placed in a center of the sheet. The structure is so called “tarpaulin”.

The thus laminated sheet comprising reinforcing layer is conveniently and variously used for the purpose of weather or sunlight protection, for example, a blind or roll curtain for window of buildings or vehicles; a sunshade or awning for balcony, terrace, street stall, outdoor party, etc.; a hanging screen (as a kind of sunshade), pavilion or tent; a cover for temporary storage house or track tarp and the like.

It is preferable to use a woven-, non-woven-, knitted fabric or net of larger meshes as an intermediate layer, if the transmittance to certain extent is required.

### EFFECTS OF THE INVENTION

As has been described above, the heat shielding sheet of the invention results in the following effects:
1. Heat rays related to rise in temperature can be effectively reduced without inhibiting visible light transparency.
2. Compared with a conventional sheet comprising ITO or ATO as a heat light shielding agent, the sheet of the invention exhibits higher heat shielding performance under a condition of the same transmittance of visible light and higher transmittance of visible light under a condition of the same performance.
3. No change in the transmittance of all light rays is observed after a Sunshine-weather-o-miter (SWOM) exposure for 2,000 hours, which demonstrates that excellent weatherability and heat shielding performance, can be kept for a long period of time even in the open air. The weather-o-miter will be detailed later.
4. A decrease in heat shielding performance and other properties of the sheet due to weathering deterioration can be prevented by adding thereto specific light stabilizers.
5. As infrared and near infrared light is certainly cut, the sheet can be used not only for the primary purpose of shielding heat light but for developing a laser beam absorbing film of high transparency.
6. Moisture condensation can be prevented by sticking the sheet on the inner surface of window glass.

### PREFERRED EMBODIMENTS OF THE INVENTION

Cesium-Tungsten Oxide (C_{S0.33}WO₃) was dispersed in a plasticizer in amounts shown in Table 1, kneaded with other compounds which composition is also shown in Table 1 by means of a Banbury mixer and then subjected to calendaring at a final roll temperature of 175° C. to yield sheets of 0.2 mm in thickness.

The transmittance of visible light ray and sunlight (all light rays) of each yielded sheet was determined. The results are shown in Table 1 below.

TABLE 1

| | Experiments | | | | | | | | |
|---|---|---|---|---|---|---|---|---|---|
| | No. 1 | No. 2 | No. 3 | No. 4 | No. 5 | No. 6 | No. 7 | No. 8 | No. 9 |
| Polyvinyl chloride* | 100 | 100 | 100 | 100 | 100 | 100 | 100 | 100 | 100 |
| Plasticizer* | 53 | 53 | 53 | 53 | 53 | 53 | 53 | 53 | 53 |
| Epoxidized soybean | 2.0 | 2.0 | 2.0 | 2.0 | 2.0 | 2.0 | 2.0 | 2.0 | 2.0 |
| oil* | | | | | | | | | |
| Composite stabilizer* | 2.5 | 2.5 | 2.5 | 2.5 | 2.5 | 2.5 | 2.5 | 2.5 | 2.5 |
| Lubricant* | 0.2 | 0.2 | 0.2 | 0.2 | 0.2 | 0.2 | 0.2 | 0.2 | 0.2 |
| Light stabilizer 4* | 0.6 | 0.6 | 0.6 | 0.6 | 0.6 | 0.6 | 0.6 | 0.6 | 0.6 |
| C_{S0.33}WO₃* | 0.2 | 2.5 | 0.4 | 0.6 | 0.9 | 1.2 | 0.6 | 0.6 | 0.6 |
| Avg. particle size (nm) | 300 | 300 | 300 | 300 | 300 | 300 | 100 | 500 | 700 |
| Visible light | 89 | 85 | 87 | 84 | 81 | 76 | 90 | 77 | 76 |
| transmittance (%) | | | | | | | | | |
| Sunlight | 70 | 35 | 65 | 57 | 49 | 42 | 58 | 56 | 57 |
| transmittance (%) | | | | | | | | | |

(*The amount is based on parts by weight)

The transmittance of visible light and sunlight was determined according to a procedure prescribed by JIS A 5759. The transmittance of visible light and sunlight described in the invention means a transmit ratio which takes intensity coefficient of the actual sun light into considering. Whereby “visible light transmittance” means transmit ratio of the actual sun light in visible light region.

The following materials were used to prepare the sheet of the invention:

# Polyvinyl chloride: average degree of polymerization 1050; available from Kaneka Co., Ltd. as trade name of S1001.

# Plasticizer: available from C. G. Ester Co., Ltd. as a trade name of DHP.

# Epoxidized soybean oil: available from Dainippon Ink Chemical Co., Ltd. as a trade name of W-100EL.

# Ba—Zn composite stabilizer: available from Adeka Co., Ltd. as a trade name of AC-255.

# Lubricant: available from Nihon Kasei Co., Ltd. as a trade name of Bisamide.

# Light stabilizer 1: benzotriazole compound; available from Akishima Kagaku Co., Ltd. as a trade name of MAF-613.

# Light stabilizer 2: cyanoacrylate compound; available from BASF as a trade name of Uvinal 303.

# Light stabilizer 3: hindered amine compound; available from Adeka Co., Ltd as a trade name of LA-68LD.

# Light stabilizer 4: a 50/50 mixture of the light Stabilizer 1 and 3.

In Experiment No. 1 to No. 9, the sunlight transmittance of 10% or less in the ultraviolet region was achieved by adding the light stabilizer 4, thereby improving the resistance to light of the heat shielding sheet.

In Experiment No. 3 to No. 9, the results were satisfactory as the sheet of the invention. With regard to the inside visibility, there was no difficulty in Experiment No. 8 although the sheet was semitransparent, while in Experiment No. 9, it was poor and the sheet exhibited an appearance of frosted glass.

In Experiment No. 4, the Tungsten Oxide particles were coated in advance with a silane coupling agent and used for kneading without pre-dispersing them in the plasticizer. In this case, there was no difficulty in dispersing the Tungsten Oxide particles. In a comparative experiment where kneading was done without silane-coating and pre-dispersion as described above, the dispersibility was poorer than that of Experiment No. 4.

In Experiment No. 10 to 14, light stabilizers 1 to 3 shown in Table 2 were used instead of the similar agent 4 used in Experiment No. 4. The sheets were subjected to a weathering test at 63±3° C. under a condition of intermittent exposure to rain water at 12 minute intervals per hour by means of “300 Sunshine Weather-o-meter available from Suga Shikenki Co., Ltd. The transmittance (%) of visible light, sunlight and ultraviolet light was determined after 0, 1,000 and 2,000 hours passed according to the procedure prescribed by JIS A 5759. The results are shown in Table 2 below.

TABLE 2

| | | Experiment | | | | |
|---|---|---|---|---|---|---|
| | | No. 10 | No. 11 | No. 12 | No. 13 | No. 14 |
| Light | Agent 1 | 90 | 30 | | 40 | 30 |
| stabilizer | Agent 2 | | 70 | 90 | 40 | 60 |
| (%) | Agent 3 | 10 | | 10 | 20 | 10 |
| Visible light | 0 hr | 84 | 84 | 84 | 84 | 84 |
| transmittance | 1,000 hrs | 83 | 83 | 83 | 83 | 83 |
| | 2,000 hrs | 83 | 82 | 82 | 83 | 82 |
| | Change | −1.2 | −2.4 | −2.4 | −1.2 | −2.4 |
| | rate (%) | | | | | |
| Sunlight | 0 hr | 57 | 57 | 57 | 57 | 57 |
| transmittance | 1,000 hrs | 60 | 58 | 59 | 56 | 55 |
| | 2,000 hrs | 65 | 61 | 60.4 | 55.5 | 54.5 |
| | Change | 15 | 7 | 6 | −2.7 | −4.4 |
| | rate (%) | | | | | |
| UV | 0 hr | 0.03 | 0.03 | 0.03 | 0.03 | 0.03 |
| transmittance | 1,000 hrs | 0.39 | 0.12 | 0.09 | 0.21 | 0.08 |
| | 2,000 hrs | 3.12 | 0.85 | 0.84 | 1.1 | 0.71 |

As shown in Table 2, the change in transmittance was only a little in the case of visible light but was considerable in cases of sunlight and ultraviolet light in Experiment No. 10 to No. 14.

The transmittance of ultraviolet light was remarkably increased in Experiment No. 10 after 2,000 hours but was not so particularly changed in Experiment No. 11 to No. 14 in which the light stabilizer 2 was used.

The transmittance of sunlight was little decreased in Experiment No. 13 and No. 14 in which the light stabilizer 1 to 3 were used, while an increased thereof was observed in Experiment No. 11 and No. 12. This suggests a decrease in the absorbability of near infrared light.

The weathering test of 2,000 hours generally corresponds to ten year exposure in the open air.

### INDUSTRIAL APPLICABILITY

The heat shielding sheet of the invention does not show a noticeable change in the transmittance of all light ranges with the passage of time and results in little deterioration of such properties because of an outstanding effect to cut heat light and high durability, i.e., resistance to climate and resistance to thermal deterioration, even when the sheet is used in an environment directly exposed to the sunlight or ultraviolet light, rain drops or dusts.

Accordingly, the heat shielding sheet of the invention is useful as an inside and outside for windows of buildings and vehicles and fits for other various uses such as a curtain, blind, sunshade, awning, hanging screen, pavilion, portable or fixed type tent for camping, field activities, etc, tarp in the open air and truck tarps

1. A heat shielding synthetic resin sheet comprising 0.4 to 2.7 g/m2 of Tungsten Oxide particles and having visible light transmittance of 70% or more and sunlight transmittance of 65% or less.

2. A heat shielding sheet claimed in claim 1 comprising 0.01 to 10 parts by weight of light stabilizers to 100 parts by weight of the synthetic resin.

3. A heat shielding sheet claimed in claim 1 in which the light stabilizers comprise at least three compounds of cyanoacrylate, benzotriazole and hindered amine.

4. A heat shielding sheet claimed in claim 1 in which a main ingredient of the light stabilizers is cyanoacrylate.

5. A heat shielding sheet claimed in claim 1 in which the Tungsten Oxide particles are mixed to the synthetic resin in a dispersed state thereof in part of the synthetic resin or in additives.

6. A heat shielding sheet claimed in claim 1 in which the sheet is having self-adhesion.

7. A heat shielding sheet claimed in claim 1 which comprises a laminate of two or more layers and at least one layer thereof is a synthetic resin sheet with the Tungsten Oxide particles.

8. A heat shielding sheet claimed in claim 7 in which at least one layer has a pattern

9. A heat shielding sheet claimed in claim 7 in which at least one of the surfaces is an adhesive layer.

10. A heat shielding sheet claimed in claim 7 which comprise a laminate of three or more layers having at least one reinforced layer.
